(19) United States
(12) Patent Application Publication
(10) Pub. No.: US 2013/0160129 A1
(43) Pub. Date: Jun. 20, 2013

(54) SYSTEM SECURITY EVALUATION

(71) Applicants: A. Bryan SARTIN, Dallas, TX (US); Gina M. GANLEY, Millstone Twp, NJ (US); Kevin LONG, Marysville, PA (US); Jo Ann JOELS, Tulsa, OK (US)

(72) Inventors: A. Bryan SARTIN, Dallas, TX (US); Gina M. GANLEY, Millstone Twp, NJ (US); Kevin LONG, Marysville, PA (US); Jo Ann JOELS, Tulsa, OK (US)

(73) Assignee: VERIZON PATENT AND LICENSING INC., Basking Ridge, NJ (US)

(21) Appl. No.: 13/329,920

(22) Filed: Dec. 19, 2011

(51) Int. Cl. G06F 11/00; G06F 21/00

(52) U.S. Cl. 726/25

(57) ABSTRACT

A computing device may receive external activity data corresponding to a target system. The external activity data may include information corresponding to network-side information relating to the target system. The computing device may identify suspicious external activity, corresponding to the external activity data, based on an activity watchlist. The activity watchlist may include information corresponding to external activity systems associated with known sources of malicious activity. The computing device may generate a system security report based on the suspicious external activity identified.

### BACKGROUND

Currently available computer technologies include security solutions for protecting networks and devices from unauthorized intrusions. However, the solutions provided by such technologies are inadequate for evaluating whether a particular system is secure. Moreover, many security solutions are limited to investigating internal system activity, fail to adequately detect on-going security breaches, and/or involve inefficient security procedures, such as on-site computer forensics.

### BRIEF DESCRIPTION OF THE DRAWINGS

FIG. 1 is a diagram of an example environment in which systems and/or methods, described herein, may be implemented;

FIG. 2 is a diagram of an example of a device of FIG. 1;

FIG. 3 is a diagram of an example network device of FIG. 1;

FIG. 4 is a diagram of example functional components of an activity investigation system according to one or more implementations described herein;

FIG. 5 is a diagram of an example process for system security evaluation according to one or more implementations described herein;

FIG. 6 is a diagram of example data structures according to one or more implementations described herein;

FIGS. 7A-7C are diagrams of example security evaluation mechanisms according to one or more implementations described herein; and

FIG. 8 is a diagram of an example security report according to one or more implementations described herein.

### DETAILED DESCRIPTION OF PREFERRED EMBODIMENTS

The following detailed description refers to the accompanying drawings. The same labels and/or reference numbers in different drawings may identify the same or similar elements.

In one or more implementations, described herein, systems and devices may be used to evaluate system security. For example, an activity investigation system may be used to scan a target system for potential vulnerabilities, identify which of the potential vulnerabilities are actual vulnerabilities, monitor external activity corresponding to the actual vulnerabilities, and analyze the external activity using one or more security evaluation mechanisms to evaluate system security. Examples of such security evaluation mechanisms may include analyzing the external activity for characteristics (e.g., an Internet Protocol (IP) address, a geographic location, a type of protocol, a frequency of communications, a data transfer quantity, etc.) that are indicative of suspicious activity (e.g., system vulnerability scanning, a system attack, malware, crimeware, spyware, a security breach, etc.). The activity investigation system may create security reports to indicate the security risks corresponding to the target system and/or may detect on-going security breaches.

Accordingly, the systems and/or devices, discussed herein, may provide an efficient and well-rounded solution to evaluating system security. For example, scanning the target system for potential vulnerabilities and identifying which of the potential vulnerabilities are actual vulnerabilities may enable the activity investigation system to focus system resources (e.g., processing capacity, memory capacity, etc.) on the aspects of the target system that are most susceptible to suspicious and/or malicious activity. Additionally, or alternatively, since the activity investigation system may be capable of analyzing multiple characteristics of external activity (e.g., an IP address, a geographic location, a type of protocol, a frequency of communications, a data transfer quantity, etc.), the activity investigation system may conduct a well-rounded analysis of whether the external activity is indicative of suspicious activity.

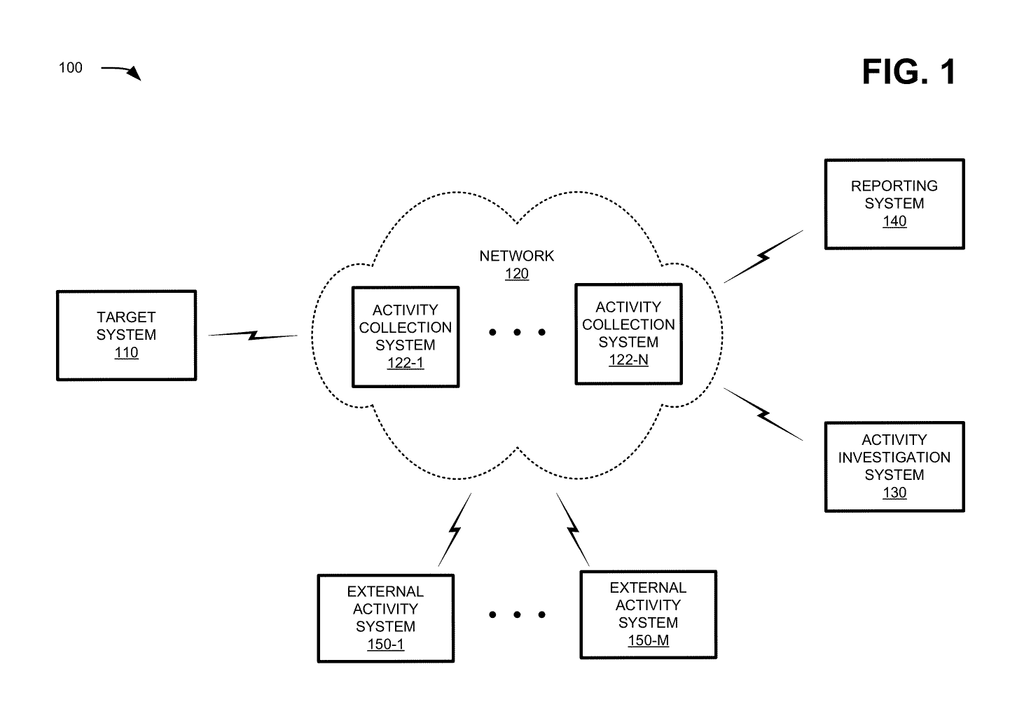

FIG. 1 is a diagram of an example environment 100 in which systems and/or methods, described herein, may be implemented. As depicted, environment 100 may include a target system 110, a network 120, activity collection systems 122-1, . . . , 122-N (where N≧1) (hereinafter referred to individually as “activity collection system 122,” and collectively as “activity collection systems 122”), an activity investigation system 130, a reporting system 140, and external activity systems 150-1, . . . , 150-M (where M≧1) (hereinafter referred to individually as “external activity system 150,” and collectively as “external activity systems 150”).

The number of systems and/or networks, illustrated in FIG. 1, is provided for explanatory purposes only. In practice, there may be additional systems and/or networks, fewer systems and/or networks, different systems and/or networks, or differently arranged systems and/or networks than illustrated in FIG. 1.

Also, in some implementations, one or more of the systems of environment 100 may perform one or more functions described as being performed by another one or more of the systems of environment 100. Systems of environment 100 may interconnect via wired connections, wireless connections, or a combination of wired and wireless connections.

Target system 110 may include one or more types of computing and/or communication devices. For example, target system 110 may include a desktop computer, a server, a cluster of servers, a router, or one or more other types of computing and/or communication devices. Target system 110 may be capable of communicating with network 120. In one example, target system 110 may include a device or network corresponding to a financial transaction processing organization (e.g., an organization that validates or underwrites credit card transactions). For instance, target system 110 may correspond to an organization that validates credit card transactions for a banking organization corresponding to reporting system 140.

Network 120 may include any type of network and/or combination of networks. For example, network 120 may include a LAN (e.g., an Ethernet network), a wireless LAN (WLAN) (e.g., an 802.11 network), a wide area network (WAN) (e.g., the Internet), a wireless WAN (WWAN) (e.g., a 3gpp System Architecture Evolution (SAE) Long-Term Evolution (LTE) network, a Global System for Mobile Communications (GSM) network, a Universal Mobile Telecommunications System (UMTS) network, a Code Division Multiple Access 2000 (CDMA2000) network, a High-Speed Packet Access (HSPA) network, a Worldwide Interoperability for Microwave Access (WiMAX) network, etc.). Additionally, or alternatively, network 120 may include a fiber optic network, a metropolitan area network (MAN), an ad hoc network, a virtual network (e.g., a virtual private network (VPN)), a telephone network (e.g., a Public Switched Telephone Network (PSTN)), a cellular network, a Voice over IP (VoIP) network, or another type of network. In one example, network 120 may include a network backbone, or portion thereof, corresponding to the Internet or another type of WAN.

Activity collection system 122 may include one or more types of computing and/or communication devices. For example, activity collection system 122 may include a desktop computer, a server, a cluster of servers, a router, a switch, or one or more other types of computing and/or communication devices. In one example, activity collection system 122 may include a router (e.g., a core router), a server, a data center, and/or another type of network system or device. Activity collection system 122 may be capable of identifying external activity data corresponding to a particular system or device (e.g., target system 110), collecting the external activity data, and/or providing the external activity data (or a copy of the external activity data) to activity investigation system 130.

Activity investigation system 130 may include one or more types of computing and/or communication devices. For example, activity investigation system 130 may include a desktop computer, a server, a cluster of servers, a router, or one or more other types of computing and/or communication devices. Activity investigation system 130 may be capable of scanning target system 110 for potential vulnerabilities, identifying which of the potential vulnerabilities are actual vulnerabilities, monitoring external activity data corresponding to the actual vulnerabilities, and/or analyzing the external activity to evaluate system security corresponding to target system 110. Additionally, or alternatively, activity investigation system 130 may be capable of communicating with reporting system 140 to, for example, provide a security report, notify reporting system 140 of an on-going security breach, etc.

Reporting system 140 may include one or more types of computing and/or communication devices. For example, reporting system 140 may include a desktop computer, a server, a cluster of servers, a router, or one or more other types of computing and/or communication devices. Reporting system 140 may be capable of communicating with activity investigation system 130 to receive security notifications corresponding to target system 110 and/or to provide security-related instructions to activity investigation system 130. In one example, reporting system 140 may correspond to a banking organization that relies on the financial transaction processing organization corresponding to target system 110. To evaluate whether target system 110 is adequately secure, the banking organization may obtain any necessary consent or approval from the financial transaction processing organization and/or enlist the system security evaluation services of activity investigation system 130.

External activity system 150 may include one or more types of computing and/or communication devices. For example, external activity system 150 may include a laptop computer, a desktop computer, a tablet computer, a mobile telephone (e.g., a smart phone), a server, a cluster of servers, a router, or one or more other types of computing and/or communication devices. In one example, external activity system 150 may include an end-user device, such as a laptop computer, a desktop computer, etc. However, external activity system 150 may also, or alternatively, include a proxy device, such as a proxy server, a remote desktop device, etc. External activity system 150 may be capable of communicating with target system 110 via network 120. In one example, external activity system 150 may be capable of interacting with target system 110 in a suspicious and/or malicious manner (e.g., by scanning target system 110 for vulnerabilities, by obtaining unauthorized access to target system 110, by obtaining data from target system 110 without authorization, etc.).

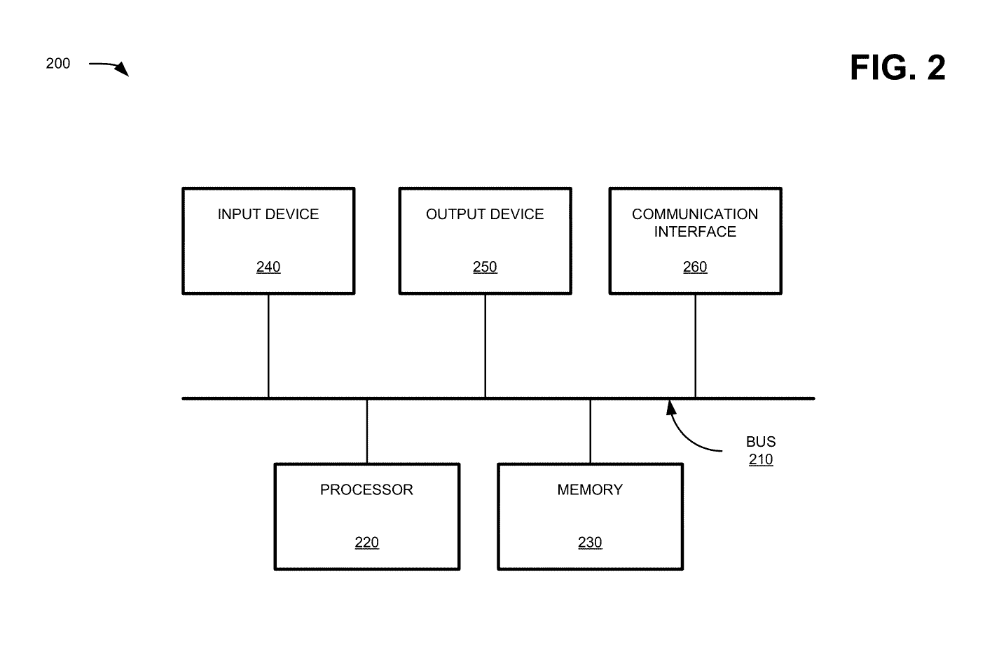

FIG. 2 is a diagram of example components of a device 200 that may be used within environment 100 of FIG. 1. Device 200 may correspond to target system 110, activity collection system 122, activity investigation system 130, reporting system 140, and/or external activity system 150. Each of target system 110, activity collection system 122, activity investigation system 130, reporting system 140, and/or external activity system 150 may include one or more of devices 200 and/or one or more of the components of device 200.

As depicted, device 200 may include bus 210, processor 220, memory 230, input device 240, output device 250, and communication interface 260. However, the precise components of device 200 may vary between implementations. For example, depending on the implementation, device 200 may include fewer components, additional components, different components, or differently arranged components than those illustrated in FIG. 2.

Bus 210 may permit communication among the components of device 200. Processor 220 may include one or more processors, microprocessors, data processors, co-processors, network processors, application-specific integrated circuits (ASICs), controllers, programmable logic devices (PLDs), chipsets, field-programmable gate arrays (FPGAs), or other components that may interpret or execute instructions or data. Processor 220 may control the overall operation, or a portion thereof, of device 200, based on, for example, an operating system (not illustrated) and/or various applications. Processor 220 may access instructions from memory 230, from other components of device 200, or from a source external to device 200 (e.g., a network or another device).

Memory 230 may include memory and/or secondary storage. For example, memory 230 may include random access memory (RAM), dynamic RAM (DRAM), read-only memory (ROM), programmable ROM (PROM), flash memory, or some other type of memory. Memory 230 may include a hard disk (e.g., a magnetic disk, an optical disk, a magneto-optic disk, a solid state disk, etc.) or some other type of computer-readable medium. A computer-readable medium may be defined as a non-transitory memory device. A memory device may include space within a single physical memory device or spread across multiple physical memory devices.

Input device 240 may include one or more components that permit a user to input information into device 200. For example, input device 240 may include a keypad, a button, a switch, a knob, fingerprint recognition logic, retinal scan logic, a web cam, voice recognition logic, a touchpad, an input port, a microphone, a display, or some other type of input component. Output device 250 may include one or more components that permit device 200 to output information to a user. For example, output device 250 may include a display, light-emitting diodes (LEDs), an output port, a speaker, or some other type of output component.

Communication interface 260 may include one or more components that permit device 200 to communicate with other devices or networks. For example, communication interface 260 may include some type of wireless or wired interface. Communication interface 260 may also include an antenna (or a set of antennas) that permit wireless communication, such as the transmission and reception of radio frequency (RF) signals.

As described herein, device 200 may perform certain operations in response to processor 220 executing software instructions contained in a computer-readable medium, such as memory 230. The software instructions may be read into memory 230 from another computer-readable medium or from another device via communication interface 260. The software instructions contained in memory 230 may cause processor 220 to perform one or more processes described herein. Alternatively, hardwired circuitry may be used in place of, or in combination with, software instructions to implement processes described herein. Thus, implementations described herein are not limited to any specific combination of hardware circuitry and software.

The number of components, illustrated in FIG. 2, is provided for explanatory purposes only. In practice, there may be additional components, fewer components, different components, or differently arranged components than illustrated in FIG. 2.

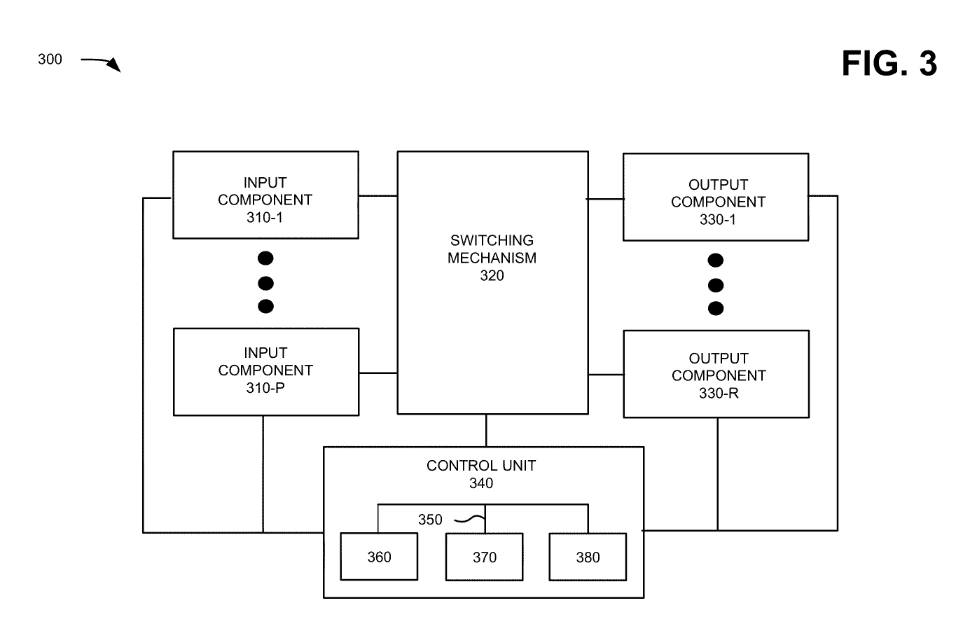

FIG. 3 is a diagram of an example network device 300 of FIG. 1 that may be used within environment 100. For example, since target system 110, activity collection system 122, activity investigation system 130, and/or external activity system 150 may include a network device, such as a router, a gateway, a firewall, a switch, etc., network device 300 may correspond to target system 110, activity collection system 122, activity investigation system 130, and/or external activity system 150. In addition, each of target system 110, activity collection system 122, activity investigation system 130, and/or external activity system 150 may include one or more network devices 300 and/or one or more of the components of network device 300.

As depicted, network device 300 may include input components 310-1, . . . , 310-P (where P≧1) (collectively referred to as “input components 310,” and individually as “input component 310”), switching mechanism 320, output components 330-1, . . . , 330-R (where R≧1) (collectively referred to as “output components 330,” and individually as “output component 330”), and control unit 340 (which may include bus 350, processor 360, memory 370, and communication interface 380). However, the precise components of network device 300 may vary between implementations. For example, depending on the implementation, network device 300 may include fewer components, additional components, different components, or differently arranged components than those illustrated in FIG. 3.

Input components 310 may be points of attachment for physical links and may be the points of entry for incoming traffic. Input components 310 may perform data link layer encapsulation and/or decapsulation. Input components 310 may look up a destination address of incoming traffic (e.g., any type or form of data, such as packet data or non-packet data) in a forwarding table (e.g., a media access control (MAC) table) to determine a destination component or a destination port for the data (e.g., a route lookup). In order to provide quality of service (QoS) guarantees, input ports 310 may classify traffic into predefined service classes. Input ports 310 may run data link-level protocols and/or network-level protocols.

Switching mechanism 320 may include a switching fabric that provides links between input components 310 and output components 330. For example, switching mechanism 320 may include a group of switching devices that route traffic from input components 310 to output components 330.

Output components 330 may store traffic and may schedule traffic on one or more output physical links. Output components 330 may include scheduling algorithms that support priorities and guarantees. Output components 330 may support data link layer encapsulation and decapsulation, and/or a variety of higher-level protocols.

Control unit 340 may interconnect with input components 310, switching mechanism 320, and output components 330. Control unit 340 may perform control plane processing, including computing and updating forwarding tables, manipulating QoS tables, maintaining control protocols, etc. Control unit 340 may process any traffic whose destination address may not be found in the forwarding table.

In one embodiment, control unit 340 may include a bus 350 that may include one or more paths that permits communication among processor 360, memory 370, and communication interface 380. Processor 360 may include a microprocessor or processing logic (e.g., an application specific integrated circuit (ASIC), field programmable gate array (FPGA), etc.) that may interpret and execute instructions, programs, or data structures. Processor 360 may control operation of network device 300 and/or one or more of the components of network device 300.

Memory 370 may include a random access memory (RAM) or another type of dynamic storage device that may store information and/or instructions for execution by processor 360, a read only memory (ROM) or another type of static storage device that may store static information and/or instructions for use by processor 360, a flash memory (e.g., an electrically erasable programmable read only memory (EEPROM)) device for storing information and/or instructions, and/or some other type of magnetic or optical recording medium and its corresponding drive. Memory 370 may also store temporary variables or other intermediate information during execution of instructions by processor 360.

Communication interface 380 may include any transceiver-like mechanism that enables control unit 340 to communicate with other devices and/or systems. For example, communication interface 380 may include a modem or an Ethernet interface to a LAN. Additionally or alternatively, communication interface 380 may include mechanisms for communicating via a wireless network (e.g., a WLAN and/or a WWAN). Communication interface 380 may also include a console port that may allow a user to interact with control unit 340 via, for example, a command line interface. A user may configure network device 300 via a console port (not shown in FIG. 3).

Network device 300 may perform certain operations, as described in detail herein. Network device 300 may perform these operations in response to, for example, processor 360 executing software instructions (e.g., computer program(s)) contained in a computer-readable medium, such as memory 370, a secondary storage device (e.g., hard disk, CD-ROM, etc.), or other forms of RAM or ROM.

The software instructions may be read into memory 370 from another computer-readable medium, such as a data storage device, or from another device via communication interface 380. The software instructions contained in memory 370 may cause processor 360 to perform processes that will be described later. Alternatively, hardwired circuitry may be used in place of, or in combination with, software instructions to implement processes described herein. Thus, implementations described herein are not limited to any specific combination of hardware circuitry and software.

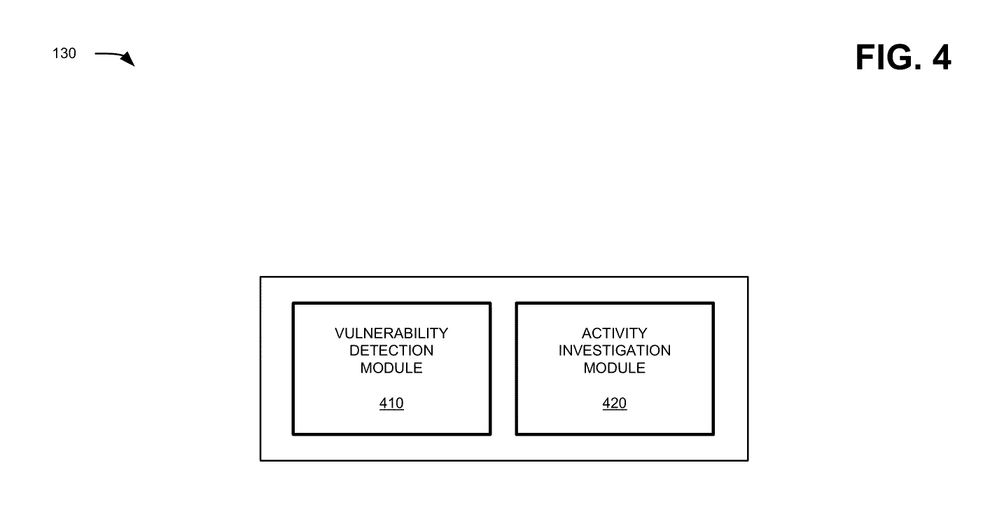

FIG. 4 is a diagram of example functional components of activity investigation system 130 according to one or more implementations described herein. As depicted, activity investigation system 130 may include vulnerability detection module 410 and activity investigation module 420. Depending on the implementation, one or more of modules 410-420 may be implemented as a combination of hardware and software based on the components illustrated and described with respect to FIG. 2. Alternatively, modules 410-420 may each be implemented as hardware based on the components illustrated and described with respect to FIG. 2.

Vulnerability detection module 410 may provide functionality with respect to system vulnerabilities. For example, vulnerability detection module 410 may enable activity investigation system 130 to detect potential system vulnerabilities corresponding to target system 110. Examples of potential system vulnerabilities may include an open port of a server, a router, or another type of network device corresponding to target system 110, retrievable system information (e.g., user names, group information, etc.) corresponding to target system 110, system application vulnerabilities corresponding to target system 110, system configuration issues corresponding to target system 110, software-version vulnerabilities corresponding to target system 110, etc. Vulnerability detection module 410 may also, or alternatively, enable activity investigation system 130 to identify actual system vulnerabilities (e.g., by verifying or testing one or more potential system vulnerabilities).

Activity investigation module 420 may provide functionality with respect to external activity corresponding to target system 110. For example, activity investigation module 420 may enable activity investigation system 130 to monitor external activity corresponding to a system vulnerability of target system 110, analyze the external activity data, and/or determine whether the external activity data amounts to a security breach or another type of suspicious activity. External activity data may include information related to any type of activity (e.g., sent or received messages, sent or received communications, etc.) occurring on a network side (e.g., via network 120) of target system 110. Additionally, or alternatively, activity investigation module 420 may enable activity investigation system 130 to create a system security report representing the level of security corresponding to target system 110.

In addition to the functionality described above, the functional components of activity investigation system 130 may also, or alternatively, provide functionality as described elsewhere in this description. Further, while FIG. 4 shows a particular number and arrangement of modules, in alternative implementations, activity investigation system 130 may include additional modules, fewer modules, different modules, or differently arranged modules than those depicted.

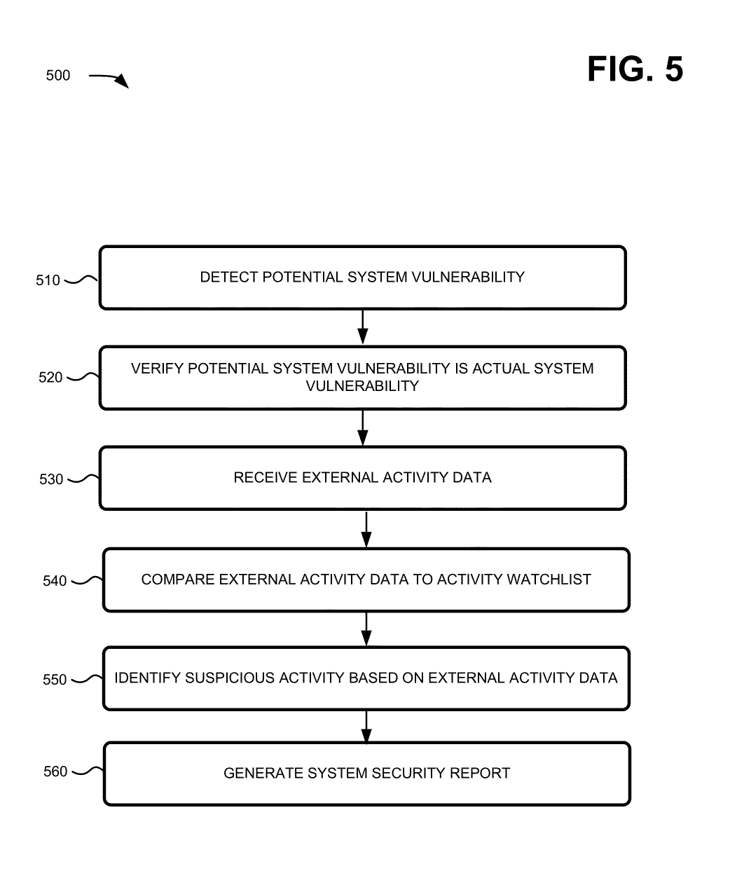

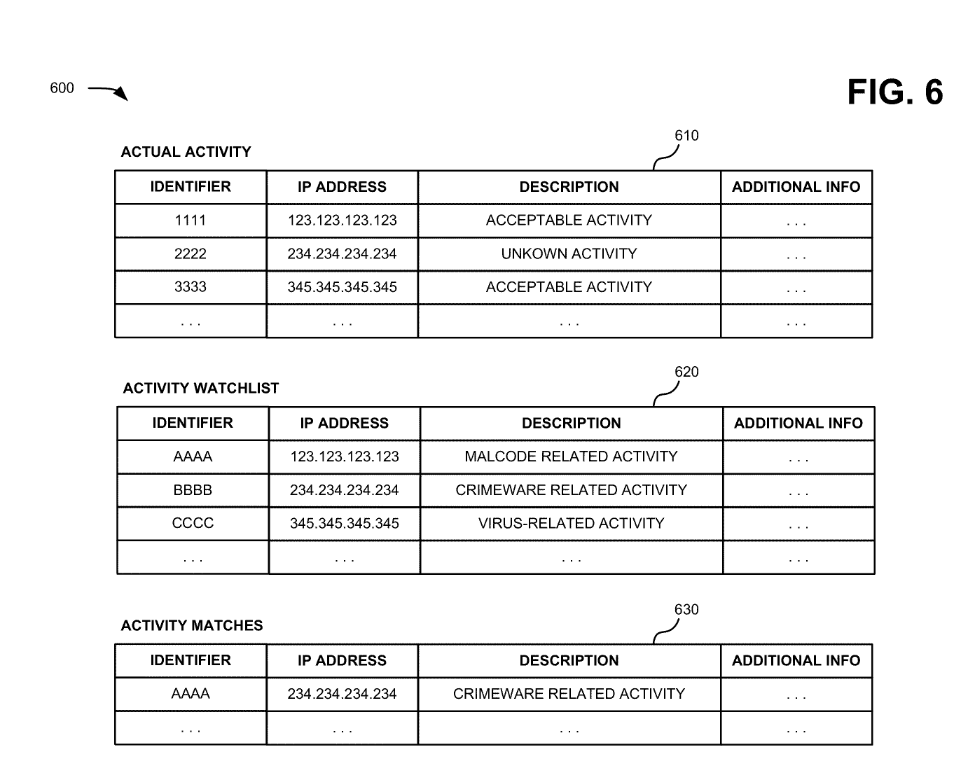

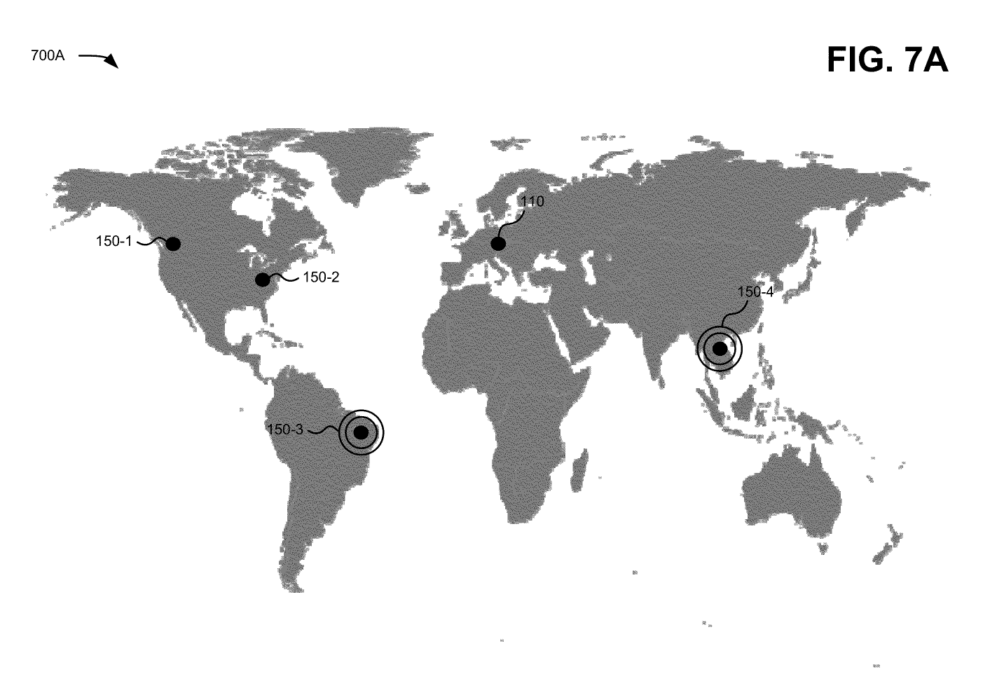

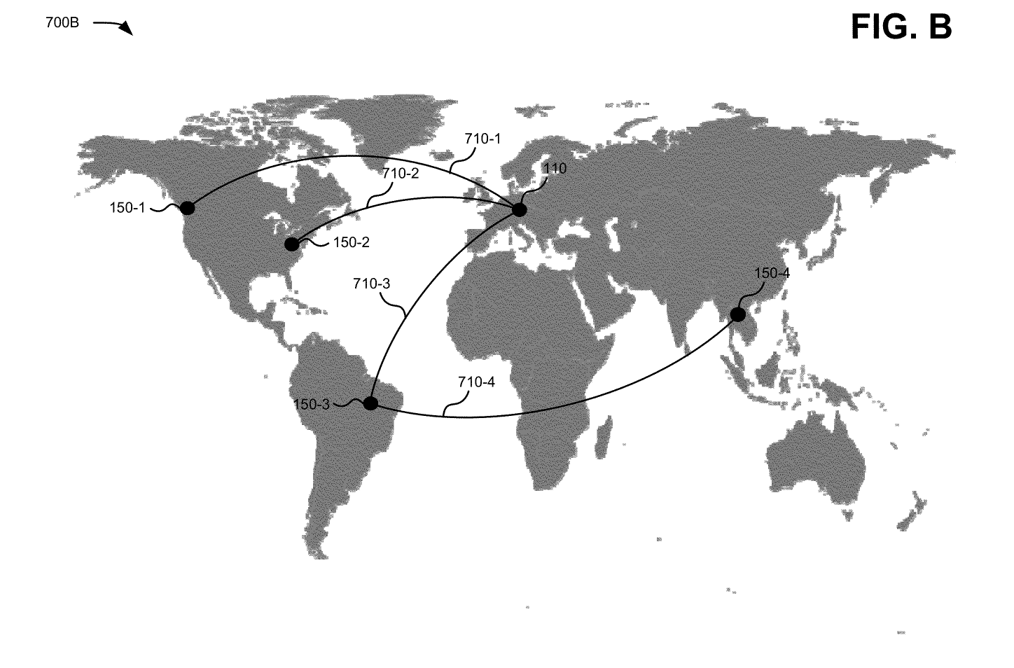

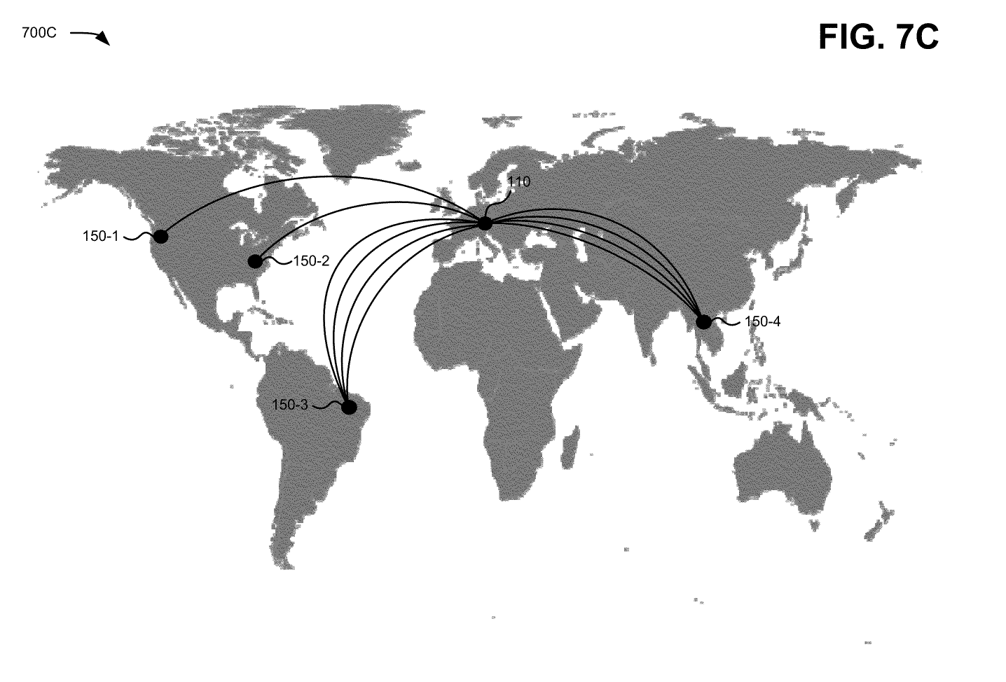

FIG. 5 is a diagram of an example process 500 for system security evaluation according to one or more implementations described herein. In one or more implementations, process 500 may be performed by one or more components of activity investigation system 130. In other implementations, some or all of process 500 may be performed by one or more other components/devices, or a group of components/devices, including or excluding activity investigation system 130. A description of FIG. 5 is provided below with reference to FIGS. 6-7C.

As shown in FIG. 5, process 500 may include detecting a potential system vulnerability (block 510). For example, activity investigation system 130 may detect a potential system vulnerability. In one example, activity investigation system 130 may detect a potential system vulnerability by executing a vulnerability scanning operation, process, and/or application directed at a target system 110 (e.g., directed at one or more of a range of IP addresses associated with target system 110). The vulnerability scanning application may be capable of detecting vulnerabilities corresponding to a port corresponding to target system 110, a software application corresponding to target system 110, an operating system corresponding to target system 110, a system setting corresponding to target system 110, a configuration corresponding to target system 110, and/or another aspect of target system 110. Detecting potential system vulnerabilities may help provide a thorough security solution by enabling activity investigation system 130 to perform a preliminary investigation with respect to a wide range of characteristics corresponding to target system 110.

Process 500 may also include verifying that the potential system vulnerability is an actual system vulnerability (block 520). For example, activity investigation system 130 may verify that the potential system vulnerability is an actual system vulnerability. In one example, activity investigation system 130 may test the potential system vulnerability by attempting to gain access to target system 110 and/or by otherwise exploiting the potential vulnerability. For instance, activity investigation system 130 may perform a port scanning operation to identify an open port corresponding to target system 110, use the port to identify an operating system running on target system 130, and/or identify the version of the operating system, thereby confirming one or more known vulnerabilities corresponding to the identified version of the operating system. Verifying that the potential system vulnerability is, in fact, an actual system vulnerability may increase efficiency by ensuring that external activity corresponding to target system 110 is worth monitoring and/or analyzing for security issues.

As shown in FIG. 5, process 500 may include receiving external activity data (block 530). For example, activity investigation system 130 may receive external activity data corresponding to target system 110. In one example, activity investigation system 130 may receive external activity data corresponding to the actual system vulnerability. For example, if a particular application, port, and/or IP address corresponding to target system 110 is associated with an actual system vulnerability, activity investigation system 130 may receive (and/or monitor) external activity data corresponding to the particular application, port, and/or IP address. As mentioned above, external activity data may include information related to any type of activity (e.g., sent or received messages, sent or received communications, etc.) occurring on a network side (e.g., via network 120) of target system 110. In some implementations, the external activity data received by activity investigation system 130 may be based on data received from activity collection system 122.

Process 500 may also, or alternatively, include identifying suspicious external activity based on an activity watchlist (block 540). For example, activity investigation system 130 may identify suspicious external activity based on an activity watchlist. The activity watchlist may include one or more known or suspected sources of suspicious and/or malicious activity. For instance, the activity watchlist may include a list of IP addresses that were previously identified as being associated with malicious activity.

FIG. 6 is a diagram of example data structures 600 according to one or more implementations described herein. As depicted, data structures 600 may include an actual activity data structure 610, an activity watchlist data structure 620, and an activity matches data structure 630. Each data structure 600 may include a table that includes an identifier column, an IP address column, a description column, etc. Actual activity data structure 610 may correspond to external activity data received by activity investigation system 130. Activity watchlist data structure 620 may correspond to known or previously identified sources of suspicious and/or malicious activity or sources of activity (e.g., an IP address).

As mentioned above, actual activity data structure 610 may be compared to activity watchlist data structure 620 to generate activity matches data structure 630, which may indicate whether any of the external activity data being monitored by activity investigation system 130 corresponds to known sources of suspicious and/or malicious activity. For instance, as depicted in the example of FIG. 6, external activity corresponding to IP address “234.234.234.2345” is indicated in activity matches data structure 630, since IP address “234.234.234.2345” is indicated in both actual activity data structure 610 and activity watchlist data structure 620. Accordingly, activity investigation system 130 may use an activity watchlist to identify known sources of suspicious and/or malicious activity that have and/or are interacting with test system 110.

Returning now to FIG. 5, process 500 may include identifying suspicious external activity based on a security evaluation mechanism (block 550). For example, activity investigation system 130 may identify suspicious external activity based on one or more security evaluation mechanisms. A security evaluation mechanism may include any type of operation, processes, and/or other type of analytical tool designed to identify a suspicious characteristic corresponding to the external activity data. A suspicious characteristic may include one or more of a variety of circumstances represented by the external activity data, such as a particular external activity system 150 interacting with target system 110 from an atypical geographic location, significant external activity occurring at an atypical time of day, a particular type of netflow (e.g., a VPN, a proxy server scenario, a remote desktop scenario, file transfer protocol (FTP), etc.), a particularly high volume of interactions within a given amount of time, a particularly large data transfer to or from target system 110, etc.

As mentioned above, the types of characteristics that qualify as suspicious external activity may depend on the type of activity that is typically experienced by target system 110. For instance, if target system 110 typically experiences a significant amount of activity during business hours, then suspicious external activity may include a significant amount of external activity occurring before or after business hours. In addition, if target system 110 typically experiences activity involving IP addresses corresponding to one geographic region, suspicious external activity may include activity involving IP addresses outside of that geographic region. Examples are provided below regarding the manner in which activity investigation system 130 may analyze external activity data for suspicious external activity.

FIG. 7A is a diagram of an example security evaluation mechanism 700A for identifying suspicious external activity according to one or more implementations described herein. As depicted in FIG. 7A, activity investigation system 130 may analyze external activity data to identify a geographic location corresponding to each external activity system 150 that interacts with the actual vulnerability of target system 110. Activity investigation system 130 may identify suspicious external activity by identifying which external activity systems (e.g., 150-1 and 150-2) are operating from typical geographic locations and/or which external activity systems (e.g., 150-3 and 150-4) are operating from atypical geographic locations.

FIG. 7B is a diagram of another example security evaluation mechanism 700B for identifying suspicious external activity according to one or more implementations described herein. As represented by the depicted example of FIG. 7B, activity investigation system 130 may analyze external activity data to identify netflows 710 corresponding to each external activity system 150 that interacts with the actual vulnerability of target system 110. In addition, activity investigation system 130 may analyze each netflow 710 for indications of suspicious activity. For instance, activity investigation system 130 may determine that netflows 710-1 and 710-2 do not involve suspicious activity since each netflow 710-1 and 710-2 involves a typical protocol (e.g., hypertext transfer protocol (HTTP)) and only small amounts of data being transferred. By contrast, activity investigation system 130 may determine that netflows 710-3 and 710-4 appear to involve suspicious activity since each of netflows 710-3 and 710-4 are part of a proxy server scenario (e.g., where external activity system 150-3 is a proxy server and external activity system 150-4 is a user device).

FIG. 7C is a diagram of another example security evaluation mechanism 700C for identifying suspicious external activity according to one or more implementations described herein. As represented by the example depicted in FIG. 7C, activity investigation system 130 may analyze external activity data to determine a quantity of times that a particular external activity system 150 interacted with target system 110 and/or an actual vulnerability of target system 110 over a given period of time. Additionally, or alternatively, activity investigation system 130 may identify suspicious external activity based on such an analysis. For example, as depicted in FIG. 7C, activity investigation system 130 may determine that the external activity data corresponding to external activity devices 150-1 and 150-2 are not indicative of suspicious activity given the relatively low quantity of interactions with target system 110. However, activity investigation system 130 may also, or alternatively, determine that the external activity data corresponding to external activity devices 150-3 and 150-4 are indicative of suspicious activity given the relatively large quantity of interactions with target system 110.

Returning now to FIG. 5, process 500 may include generating a system security report (block 560). For example, activity investigation system 130 may generate a system security report. In some implementations, the system security report may include any variety or combination of information relating to the evaluation of a security system (e.g., target system 110), such as a target system identifier, a monitoring period (e.g., a period of time that the security system was monitored), identified types of suspicious activity, etc.

While FIG. 5 shows a flowchart diagram of an example process 500 for system security evaluation, in other implementations, a process for system security evaluation may include fewer operations, different operations, differently arranged operations, or additional operations than depicted in FIG. 5. For example, if activity investigation system 130 is able to verify that the potential system vulnerability is not an actual system vulnerability, activity investigation system 130 may generate a security report, or another type of response, indicating that target system 110 does not appear to include any actual system vulnerabilities.

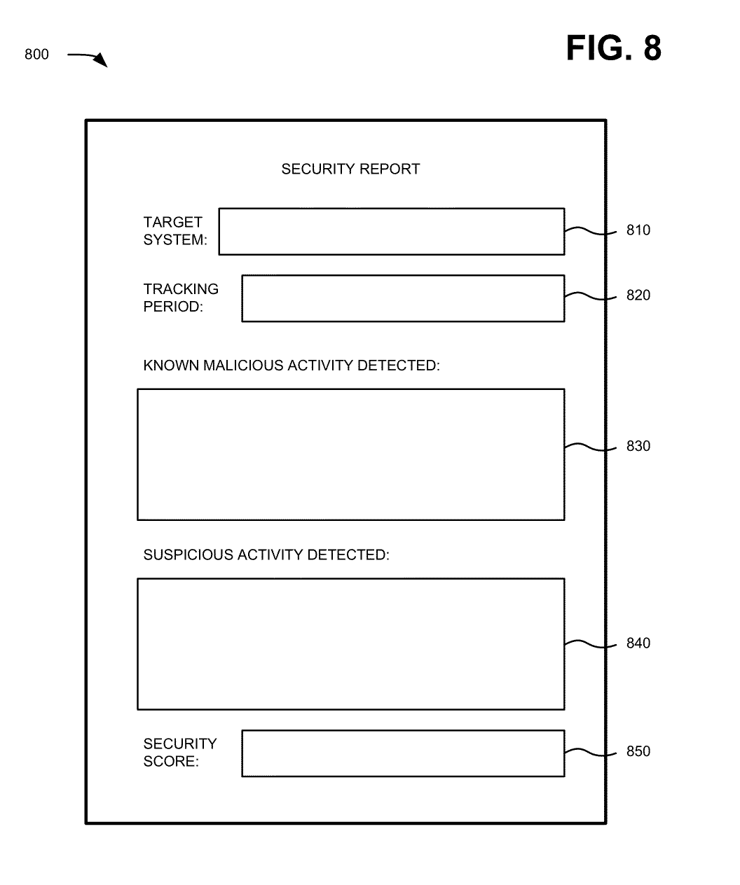

FIG. 8 is an example security report 800 according to one or more implementations described herein. As depicted in FIG. 8, security report 800 may include a target system text box 810 for identifying a particular target system 110, a tracking period text box 820 for identifying a period of time that external activity corresponding to the target system 110 has been monitored, and a system vulnerabilities text box 830 for identifying actual system vulnerabilities. Security report 800 may also include a suspicious activity text box 840 for identifying suspicious external activity that has been detected with respect to target system 810, and a security score text box for indicating an overall security corresponding to target system 110. While FIG. 8 shows a diagram of an example security report 800, in other implementations, a security report may include fewer information, different information, differently arranged information, or additional information than depicted in FIG. 8. For instance, a security report may include one or more of the maps depicted in FIGS. 7A-7C or another type of graphical display of external activity and/or analysis thereof.

Accordingly, systems and devices, as described herein, may be used to evaluate system security. Activity investigation system 130 may be used to scan target system 110 for potential vulnerabilities, identify which of the potential vulnerabilities are actual vulnerabilities, monitor external activity corresponding to the actual vulnerabilities, and analyze the external activity using one or more security evaluation mechanisms to evaluate system security. Additionally, or alternatively, activity investigation system 130 may create security reports to indicate the security risks corresponding to the target system and/or may detect on-going security breaches.

As such, activity investigation system 130 may provide an efficient and well-rounded solution to evaluating system security. Scanning target system 110 for potential vulnerabilities and identifying which of the potential vulnerabilities are actual vulnerabilities may enable activity investigation system 130 to focus system resources on the aspects of target system 110 that are most susceptible to suspicious and/or malicious activity. Additionally, or alternatively, since activity investigation system 130 may be capable of analyzing multiple characteristics of external activity, activity investigation system 130 may conduct a well-rounded analysis of whether the external activity is indicative of suspicious activity.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code--it being understood that software and control hardware could be designed to implement the aspects based on the description herein.

Further, certain implementations may involve a component that performs one or more functions. These components may include hardware, such as an ASIC or a FPGA, or a combination of hardware and software.

Even though particular combinations of features are recited in the claims and/or disclosed in the specification, these combinations are not intended to limit disclosure of the possible implementations. In fact, many of these features may be combined in ways not specifically recited in the claims and/or disclosed in the specification. Although each dependent claim listed below may directly depend on only one other claim, the disclosure of the implementations includes each dependent claim in combination with every other claim in the claim set.

No element, act, or instruction used in the present application should be construed as critical or essential to the implementations unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
receiving, by a computing device, external activity data corresponding to a target system,
where the external activity data comprises information corresponding to network-side information relating to the target system;
identifying, by the computing device, suspicious external activity, corresponding to the external activity data, based on an activity watchlist,
where the activity watchlist comprises information corresponding to external activity systems associated with known sources of malicious activity; and
generating, by the computing device, a system security report based on the suspicious external activity identified.

2. The method of claim 1, further comprising:
detecting a potential system vulnerability corresponding to the target system; and
verifying that the potential system vulnerability comprises an actual system vulnerability.

3. The method of claim 2, where detecting the potential system vulnerability comprises:
executing a vulnerability scan operation directed at the target system.

4. The method of claim 2, where the external activity data is limited to external activity data corresponding to the actual system vulnerability.

5. The method of claim 1, further comprising:
identifying suspicious external activity, corresponding to the external activity data, based on a security evaluation mechanism, where the security evaluation mechanism comprises an operation to identify a suspicious characteristic corresponding to the external activity data.

6. The method of claim 5, where the suspicious characteristic comprises at least one of:
a particular external activity system interacting with the target system from an atypical geographic location,
external activity occurring at an atypical time of day for the target system,
an external activity system interacting with the target system via a virtual private network,
an external activity system interacting with the target system via a proxy server,
an external activity system interacting with the target system via a remote desktop device,
an atypical volume of interactions between an external activity system and the target system, or
an atypical data transfer between an external activity system and the target system.

7. The method of claim 1, where the system security report comprises information describing a level of security corresponding to the target system.

8. The method of claim 1, further comprising:
providing the system security report to a reporting system to notify the reporting system of a level of security corresponding to the target system.

9. A computing device, comprising:
a memory to store instructions; and
a processor, connected to the memory, to execute the instructions to:
receive external activity data corresponding to a target system,
where the external activity data comprises information
corresponding to network-side information relating to the target system,
identify suspicious external activity, corresponding to the external activity data, based on an activity watchlist,
where the activity watchlist comprises information corresponding to external activity systems associated with known sources of malicious activity;
identify suspicious external activity, corresponding to the external activity data, based on a security evaluation mechanism,
where the security evaluation mechanism comprises an operation to identify a suspicious characteristic corresponding to the external activity data; and
generate a system security report based on the suspicious external activity identified.

10. The computing device of claim 9, where the processor is further to:
detect a potential system vulnerability corresponding to the target system, and
verify that the potential system vulnerability comprises an actual system vulnerability.

11. The computing device of claim 10, where, to detect the potential system vulnerability, the processor is to:
execute a vulnerability scan operation directed at the target system.

12. The computing device of claim 10, where the external activity data is limited to external activity data corresponding to the actual system vulnerability.

13. The computing device of claim 9, where the suspicious characteristic comprises at least one of:
a particular external activity system interacting with the target system from an atypical geographic location,
external activity occurring at an atypical time of day for the target system,
an external activity system interacting with the target system via a virtual private network,
an external activity system interacting with the target system via a proxy server,
an external activity system interacting with the target system via a remote desktop device,
an atypical volume of interactions between an external activity system and the target system, or
an atypical data transfer between an external activity system and the target system.

14. The computing device of claim 9, where the system security report comprises information describing a level of security corresponding to the target system.

15. The computing device of claim 9, where the processor is further to:
provide the system security report to a reporting system to notify the reporting system of a level of security corresponding to the target system.

16. One or more non-transitory computer-readable storage media, comprising:
one or more instructions that, when executed by a processor, cause the processor to:
detect a potential system vulnerability corresponding to a target system,
verify that the potential system vulnerability comprises an actual system vulnerability,
receive external activity data corresponding to the target system,
where the external activity data comprises information
corresponding to network-side information relating to the target system,
identify suspicious external activity, corresponding to the external activity data, based on an activity watchlist,
where the activity watchlist comprises information corresponding to external activity systems associated with known sources of malicious activity;
identify suspicious external activity, corresponding to the external activity data, based on a security evaluation mechanism,
where the security evaluation mechanism comprises an operation to identify a suspicious characteristic corresponding to the external activity data; and
generate a system security report based on the suspicious external activity identified.

17. The computer-readable storage media of claim 16, where the one or more instructions cause the processor to:
execute a vulnerability scan operation directed at the target system to detect the potential system vulnerability.

18. The computer-readable storage media of claim 16, where the external activity data is limited to external activity data corresponding to the actual system vulnerability.

19. The computer-readable storage media of claim 16, where the suspicious characteristic comprises at least one of:
a particular external activity system interacting with the target system from an atypical geographic location,
external activity occurring at an atypical time of day for the target system,
an external activity system interacting with the target system via a virtual private network,
an external activity system interacting with the target system via a proxy server,
an external activity system interacting with the target system via a remote desktop device,
an atypical volume of interactions between an external activity system and the target system, or
an atypical data transfer between an external activity system and the target system.

20. The computer-readable storage media of claim 16, where the system security report comprises information describing a level of security corresponding to the target system.
